(19) United States
(12) Patent Application Publication
(10) Pub. No.: US 2011/0205599 A1
(43) Pub. Date: Aug. 25, 2011

(54) IMAGE READING DEVICE AND IMAGE FORMING APPARATUS

(76) Inventors: Takeshi KATO, Osaka (JP); Takahiro Bito, Osaka (JP); Toru Nishikawa, Osaka (JP); Junichi Saito, Osaka (JP); Kazuki Takatsuka, Osaka (JP); Hitoshi Nagahama, Osaka (JP)

(21) Appl. No.: 13/031,201

(22) Filed: Feb. 19, 2011

(30) Foreign Application Priority Data
Feb. 24, 2010 (JP) 2010-039287

(51) Int. Cl. H04N 1/04

(52) U.S. Cl. 358/474

(57) ABSTRACT

A memory storage section in which a memory attachment section is provided is provided in a place of a platen which place is to be covered with a platen cover. This makes it possible to prevent a young child from accidentally detaching a portable recording medium detachably attached to an image reading device.

This Nonprovisional application claims priority under 35 U.S.C. §119(a) on Patent Application No. 2010-039287 filed in Japan on Feb. 24, 2010, the entire contents of which are hereby incorporated by reference.

### TECHNICAL FIELD

The present invention relates to: an image reading device from which a portable recoding medium (removable media) is detachable; and an image forming apparatus including the image reading device.

### BACKGROUND ART

Conventionally, image processing devices such as a multifunction printer, a copying machine, a scanner, a printer and a facsimile from each of which a portable recording medium (removable media) such as a memory card and an USB flash drive is detachable have been commercially available. These image processing devices read image data from the portable recording medium attached to the image processing devices, store image data in the attached portable recording medium, and read firmware, an option soft or the like from the attached portable recording medium to install the firmware, the option soft or the like.

For example, Patent Literature 1 discloses an arrangement in which a memory slot into which a memory card or the like is inserted is provided on a front surface of an image reading device.

Further, Patent Literature 2 discloses an arrangement in which a card insertion section including a card slot for connecting a removable memory is provided on a front surface of a printer which card insertion section is provided with a protective cover that covers the card insertion section.

Further, Patent Literature 3 discloses an arrangement in which a memory card attachment section to which a memory card is attached is provided in a place adjacent to a control panel that is on an upper surface of a copying machine which memory card attachment section is provided with a sliding cover. Patent Literature 3 also discloses an arrangement in which: the memory card is stored in a malfunction prevention component while the memory card is not used; and the malfunction prevention component in which the memory card is stored is fixed, by use of screws, to an inner surface of an exterior cover (front door) of the copying machine which exterior cover is opened at the time of maintenance of the copying machine or at the time of paper jam removal of the copying machine. In this manner, the memory card is stored.

Further, Patent Literature 4 discloses an arrangement in which a memory card connection section is provided on a front surface of a top cover that presses a document placed on a platen.

Further, Patent Literature 5 discloses an arrangement in which a lens cover that is large enough to cover both a shooting lens and a memory card storage section is provided slidably to a place where the shooting lens and the memory card storage section are covered with the lens cover, a place where the shooting lens is not covered and the memory card storage section is covered with the lens cover, and a place where neither the shooting lens nor the memory card storage section are covered with the lens cover.

### CITATION LIST

### Patent Literature

Patent Literature 1
Japanese Patent Application Publication Tokukai No. 2008-53819 A (Publication Date: Mar. 6, 2008)
Patent Literature 2
Japanese Patent Application Publication Tokukai No. 2005-59295 A (Publication Date: Mar. 10, 2005)
Patent Literature 3
Japanese Patent Application Publication Tokukai No. 2006-175613 A (Publication Date: Jul. 6, 2006)
Patent Literature 4
Japanese Patent Application Publication Tokukai No. 2007-150685 A (Publication Date: Jun. 14, 2007)
Patent Literature 5
Japanese Patent Application Publication Tokukai No. 2005-348300 A (Publication Date: Dec. 15, 2005)

### SUMMARY OF INVENTION

### Technical Problem

A portable recording medium has been reduced in its size. This makes it possible to improve portability thereof. Meanwhile, the portable recording medium is such small that a young child (infant or toddler) accidentally swallows the portable recording medium. This possibly causes a serious accident. To prevent such a serious accident, it is desirable that the portable recording medium which is detachable from an image processing device and which is attached to the image processing device cannot be easily detached from the image processing device by the young child.

However, the arrangements disclosed in the above Patent Literatures are arrangements in each of which the portable recording medium can be relatively easily detached from the image processing device. These arrangements will unfortunately allow the young child to accidentally detach the portable recording medium from the image processing device.

Specifically, according to a technique of Patent Literature 1, a memory slot into which a memory card or the like is inserted is provided on a front surface of an image reading device. This will unfortunately allow the young child to accidentally detach the memory card.

Further, according to a technique of Patent Literature 2, a protective cover is provided to cover a card insertion section. However, the card insertion section and the protective cover are provided on a front surface of a printer, and the protective cover can be easily opened by a load applied from above downward on the protective cover. Therefore, in a case where the young child puts his/her hand on the protective cover, the protective cover is easily opened by the young child. As a result, the card insertion section is exposed to the outside. This will unfortunately allow the young child to accidentally detach the memory card.

Further, according to a technique of Patent Literature 3, a memory card attachment section is provided on a front surface of a copying machine. This will also unfortunately allow the young child to accidentally detach the memory card, as is the case for Patent Literature 1.

Patent Literature 3 also discloses that the memory card is stored in a malfunction prevention component fixed, by use of screws, to an inner surface of an exterior cover of the copying machine. However, this storage is just for storing the memory card that is not used. This storage is not for attaching the memory card such that the copying machine is capable of writing/reading data on/from the memory card. Further, it is considerable that the memory card attachment section of Patent Literature 3 is provided in the malfunction prevention component so that the young child cannot accidentally detach the memory card. However, in this case, it is necessary to open the exterior cover and then detach the screwed malfunction prevention component in order to attach/detach the memory card. This remarkably impairs convenience for a user, and therefore this is not practical.

Further, according to a technique of Patent Literature 4, a memory card connection section is provided on a front surface of a top cover that presses a document placed on a platen. This will unfortunately allow the young child to accidentally detach the memory card, as is the case for Patent Literature 1.

Further, according to a technique of Patent Literature 5, a memory card storage section is easily exposed to the outside by sliding a lens cover. This will unfortunately allow the young child to accidentally detach the memory card.

The present invention is made in terms of the above problems, and an object of the present invention is to prevent the young child from accidentally detaching the portable recording medium that is detachably attached to the image reading device or an image forming apparatus.

### Solution to Problem

An image reading device of the present invention, to attain the object, includes: a platen including a platen region on which a document is to be placed and a frame section that surrounds the platen region; a platen cover provided rotatably about a rotating shaft provided on an edge of the platen such that the platen cover rotates between a position where the platen cover covers at least a part of the frame section and the platen region and a position where the platen cover allows the frame section and the platen region to be exposed to an outside; an image reading section that reads the document placed on the platen region; and a memory attachment section to which a portable recording medium is to be detachably attached, the memory attachment section being provided in a place of the frame section which place is to be covered with the platen cover.

### Advantageous Effects of Invention

According to the above arrangement, the memory attachment section is provided in the place of the frame section of the platen which place is to be covered with the platen cover. This makes it possible to reduce a possibility that a young child touches the portable recording medium and therefore to reduce a risk that the young child accidentally detaches the portable recording medium even in a case where the portable recording medium remains attached to the memory attachment section.

### BRIEF DESCRIPTION OF DRAWINGS

FIG. 1(a) is a perspective view of an image reading device included in an image forming apparatus in accordance with an embodiment of the present invention.

FIG. 1(b) is a perspective view of a memory storage section included in an image forming apparatus in accordance with an embodiment of the present invention.

FIG. 2 is a cross-sectional view schematically showing an image forming apparatus in accordance with an embodiment of the present invention.

FIG. 3 is a block diagram of an image forming apparatus in accordance with an embodiment of the present invention.

FIG. 4(a) is a view showing a state in which an opening/closing lid of a memory storage section shown in FIG. 1(b) is closed and a platen cover is also closed.

FIG. 4(b) is a view showing a state in which an opening/closing lid of a memory storage section shown in FIG. 1(b) is open.

FIG. 5 is a perspective view showing a modified example of an image reading device shown in FIG. 1(a).

FIG. 6 is a perspective view showing a modified example of an image reading device shown in FIG. 1(a).

### DESCRIPTION OF EMBODIMENTS

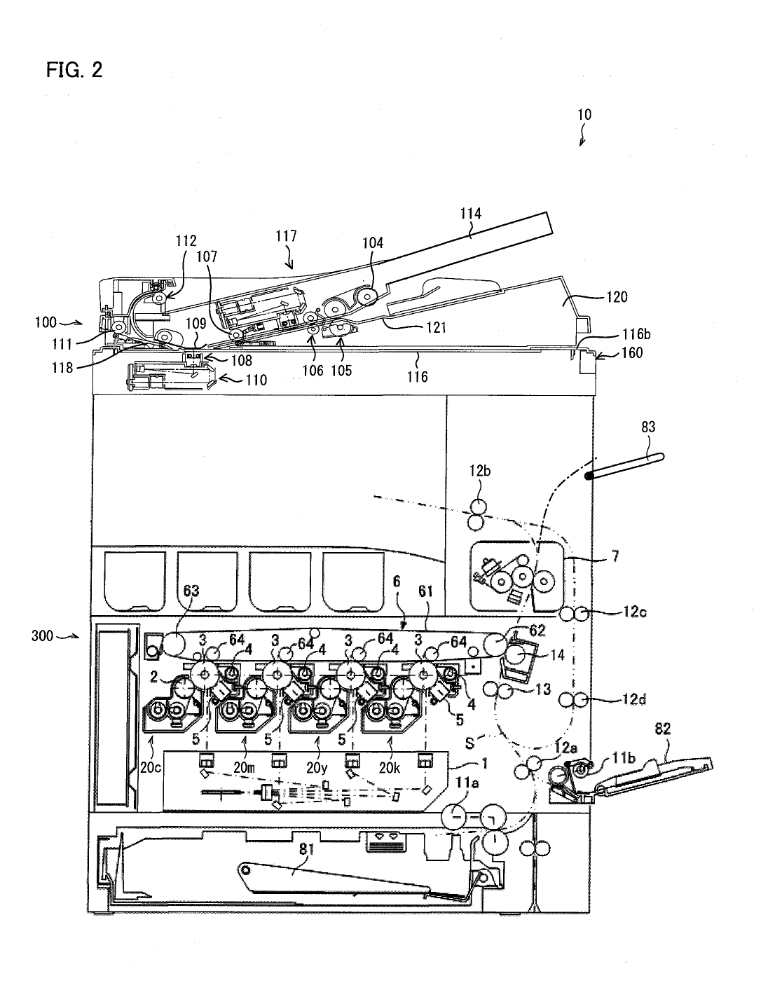

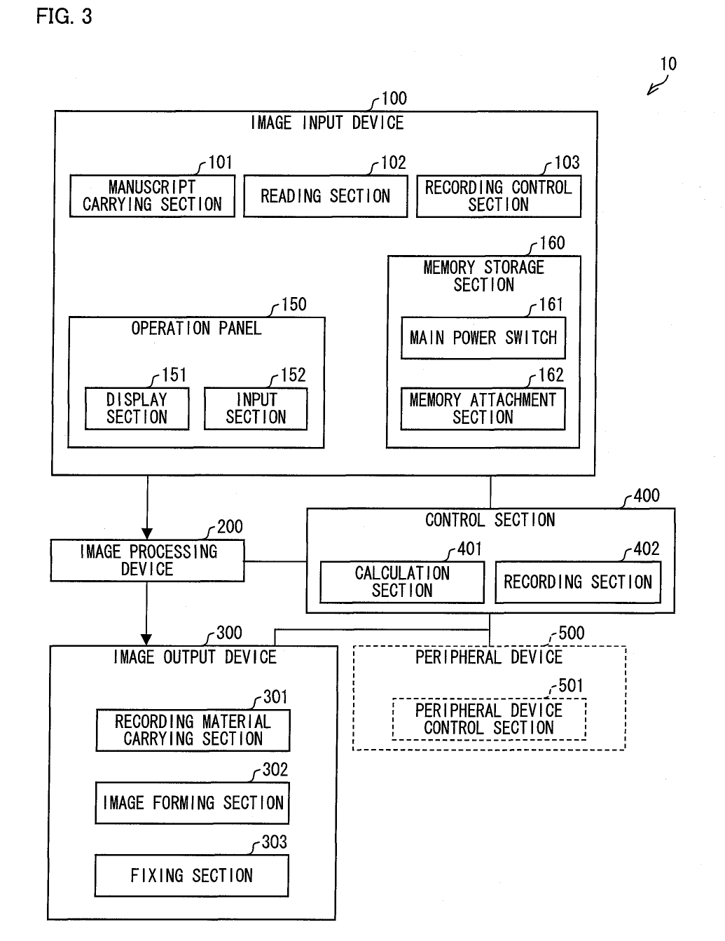

The following describes an embodiment of the present invention. FIG. 2 is a view schematically showing an arrangement of an image forming apparatus 10 in accordance with the present embodiment. FIG. 3 is a block diagram of the image forming apparatus 10.

As shown in FIG. 3, the image forming apparatus 10 includes an image reading device 100, an image processing device 200, an image output device 300 and a control section 400. As shown in FIG. 3, the image forming apparatus 10 may be provided with a peripheral device 500 as appropriate. Examples of the peripheral device 500 encompass: a paper feeding device that accommodates a recording material supplied to the image output device 300; and post-processing devices that conduct stapling, sorting, punching, bookbinding and like processes with respect to the recording material on which an image has been formed by the image output device 300.

The control section 400 includes a calculation section 401 and a recording section 402, and controls operations of the devices included in the image forming apparatus 10, that is, the image reading device 100, the image processing device 200 and the image output device 300. In a case where the image forming apparatus 10 is provided with the peripheral device 500, the control section 400 transmits a control signal to a peripheral device control section 501 included in the peripheral device 500 to control an operation of the peripheral device 500.

The recording section 402 stores various commands and set values inputted from a user via a control panel 150, detection results of various sensors provided in the image forming apparatus 10, image information read from a portable recording medium (removable media that is not shown) inserted into a memory attachment section 162, image information or firmware inputted from peripheral equipment connected communicably to the image forming apparatus 10, various set values and data tables for controlling the operations of the devices included in the image forming apparatus 10, a program for executing various controls, and the like. Examples of the recording section 402 encompass various storage means often used in this field such as a read only memory (ROM), a random access memory (RAM) and a hard disc drive (HDD). Further, examples of the peripheral equipment encompass various electronics devices which are capable of generating or acquiring image information and which are connected communicably to the image forming apparatus 10, such as a digital camera and a computer that is connected to the image forming apparatus 10 via a network.

The calculation section 401 extracts the various information stored in the recording section 402 and the program for executing the various controls, and then conducts a calculation process and/or a determination process on the basis of the extracted various information and program. Thereafter, the calculation section 401 transmits a control signal in accordance with these process results to the devices included in the image forming apparatus 10 to control the operations of the devices. The calculation section 401 is a process circuit attained by a microcomputer, a microprocessor or the like including a Central Processing Unit (CPU).

As shown in FIG. 2, the image reading device 100 is provided on an upper surface of a housing that accommodates the image output device 300. The image reading device 100 reads a document and acquires image data of the document. The image data of the document read by the image reading device 100 is carried to the image processing device 200. The image processing device 200 conducts a predetermined image process with respect to the image data of the document.

As shown in FIG. 2, the image reading device 100 includes a platen glass (platen region) 116, a platen 116b including the platen glass 116 and a peripheral section (frame section) surrounding the platen glass 116, and a platen cover 120. The platen cover 120 is provided with an automatic carrying unit 117. Further, the platen cover 120 is rotatably attached at its edge in the direction in which FIG. 2 is viewed. The platen cover 120 is rotatable such that a surface of the platen 116b is covered with the platen cover 120 and the surface of the platen 116b is not covered with the platen cover 120 to be exposed to the outside.

Further, an image reading section 110 is provided below the platen glass 116. The image reading section 110 is controlled by a reading section 102. The reading section 102 commands the image reading section 110 to read a document placed on the platen glass 116 while moving in a horizontal direction along the platen glass 116. As a result, the image reading section 110 acquires image data of the document. Specifically, the image reading section 110 includes a light source that illuminates the document with light for reading the document and an image sensing element such as a Charge Coupled Device (CCD) that converts optical information into an electric signal. The light source illuminates the document with the light emitted from the light source while the image reading section 110 moves relatively to the document. The image sensing element receives light reflected by the document, and converts optical information of the reflected light into the electric signal. In this manner, the image reading section 110 acquires the image data of the document.

The automatic carrying unit 117 includes a document setting tray 121, a pick-up roller 104, a feeding roller 105, carrying rollers 106 and 107, discharge rollers 111 and 112, a discharge tray 114 and a carrying direction switching section 118. The rollers and the carrying direction switching section 118 are controlled by a document carrying section 101. Specifically, the pick-up roller 104 picks up a document placed on the document setting tray 101 one by one. Thereafter, the feeding roller 105, and the carrying rollers 106 and 107 carry the picked-up document to a document reading position 108 where the image reading section 110 reads the document. A place where the image reading section 110 reads the document carried by the automatic carrying unit 117 is constantly the document reading position 108. Further, a read guide 109 is provided in a region facing the document reading position 108 via the platen glass 116. The document carried by the automatic carrying unit 117 passes through between the platen glass 116 and the read guide 109. The image reading section 110 illuminates, with the light emitted from the light source, a lower surface of the document that passes through between the platen glass 116 and the read guide 109, and receives the light reflected by the document. In this manner, the image reading section 110 acquires the image data of the document.

The carrying direction switching section 118 switches, to a direction of the discharge roller 111 or a direction of the discharge roller 112, a direction in which the document that has passed through the image reading section 110 is carried.

Further, the image reading device 100 includes an operation panel 150 and a memory storage section 160. The operation panel 150 and the memory storage section 160 are described in detail later.

The image processing device 200 conducts image processes with respect to the image data of the document read and acquired by the image reading device 100, image data read from the portable recording medium attached to the memory attachment section 162, or image data acquired through a communication device (not shown) from an external device communicably connected to the image forming apparatus 10 so that these image data become image data suitable for a printing process conducted by the image output device 300. Thereafter, the image processing device 200 outputs these image data suitable for the printing process to the image output device 300. Specifically, the image processes conducted with respect to these image data by the image processing device 200 are A/D conversion, shading compensation, region separation, input tone correction, color correction, spatial filtering, enlarging and reducing, halftone generation and like processes.

The image output device 300 forms (prints), on a recording material, an image corresponding to the image data inputted from the image processing device 200.

An arrangement of the image output device 300 is not particularly limited. An electrophotographic image output device is employed as the image output device 300 of the present embodiment. Specifically, as shown in FIG. 2, the image output device 300 of the present embodiment includes a feeding tray 81, a manual paper feeding tray 82, pick-up rollers 11a and 11b, carrying rollers 12a, 12b, 12c and 12d, image forming units 20c, 20m, 20y and 20k, an intermediate transfer device 6, a second transfer roller 14 and a fixing device 7.

A recording material carrying section 301 commands the pick-up rollers 11a and 11b, the carrying rollers 12a, 12b, 12c and 12d and like rollers (i) to carry, to a section where the second transfer roller 14 faces the intermediate transfer device 6, a recording material placed on the feeding tray 81 or the manual paper feeding tray 82, or a recording material turned up from a side of the recording medium on which side the fixing device 7 has conducted a fixing process to the other side of the recording medium, (ii) to carry, to the fixing device 7, the recording material to which a toner image has been transferred in the section where the second transfer roller 14 faces the intermediate transfer device 6, and (iii) to discharge, to the discharge tray 83, the recording material on which the fixing process has been conducted by the fixing device 7.

An image forming section 302 commands the image forming units 20c, 20m, 20y and 20k, the intermediate transfer device 6 and the second transfer roller 14 to form the toner image corresponding to the image data and then to transfer the formed toner image to the recording material.

The image forming units 20c, 20m, 20y and 20k form, according to the image data, toner images of cyan, magenta, yellow and black, respectively. These image forming units have substantially identical arrangements with one another other than an arrangement that these image forming units use different colors from one another. The present embodiment describes a case where a toner image is formed by the four colors of cyan, magenta, yellow and black. However, the color is not limited to the four colors. The toner image may be formed by six colors in which light cyan (LC) and light magenta (LM) are included in addition to the four colors. The light cyan and the light magenta have hues identical to those of the cyan and the magenta, respectively, but have colors lighter that those of the cyan and the magenta, respectively. The image forming units each include: a photoreceptor drum 3; a charger 5 that evenly charges a surface of the photoreceptor drum 3; a light scanning unit 1 that illuminates the charged surface of the photoreceptor drum 3 with light in accordance with image data of a color corresponding to one of the image forming units to form an electrostatic latent image on the surface of the photoreceptor drum 3; a developing device 2 that develops the electrostatic latent image formed on the surface of the photoreceptor drum 3 by use of a toner of the color corresponding to the one of the image forming units; and a cleaning device 4 that removes a toner which has not transferred from the photoreceptor drum 3 to an intermediate transfer belt 61 described later to be left on the surface of the photoreceptor drum 3.

The intermediate transfer device 6 includes support rollers 62 and 63, the intermediate transfer belt 61 that rotatably surrounds the support rollers 62 and 63, transfer rollers 64 disposed so as to face the respective photoreceptor drums 3 via the intermediate transfer drum 61. To the respective transfer rollers 64, a voltage having a polarity opposite to a charging polarity of the toner image formed on the surface of the photoreceptor drum 3 is applied. This allows the toner image, of the respective colors, formed on the surface of the photoreceptor drum 3 to overlap on the intermediate transfer belt 61 and then to be transferred to the intermediate transfer belt 61. Thereafter, the toner image transferred to the intermediate transfer belt 61 is carried to a section where the transferred toner image faces the second transfer roller 14 by rotation of the intermediate transfer belt 61.

In synchronization with carrying the toner image transferred to the intermediate transfer belt 61 to the section where the transferred toner image faces the second transfer roller 14, a recording material on which the toner image is to be transferred is carried between the second transfer roller 14 and the intermediate transfer belt 61. That is, any one of recording materials (1), (2) and (3) is carried between the second transfer roller 14 and the intermediate transfer belt 61. The recording material (1) is a recording material which is picked up from the feeding tray 81 by the pick-up roller 11a and which is then carried by the carrying roller 12a, a resist roller 13 and like rollers. The recording material (2) is a recording material which is picked up from the manual paper feeding tray 82 by the pick-up roller 11b and which is then carried by the carrying roller 12a, the resist roller 13 and like rollers. The recording material (3) is a recording material which is turned up, due to switchback conducted by the carrying roller 12d, from a side of the recording material on which side the fixing device 7 has conducted a fixing process to the other side of the recording material and which is carried again by the carrying rollers 12c and 12d, the resist roller 13 and like rollers. Further, to the second transfer roller 14, a high voltage having the polarity opposite to the charging polarity of the toner is applied. This allows the toner image transferred to the intermediate transfer belt 61 to be transferred again to the recoding materials (1), (2) or (3).

A fixing section 303 commands the fixing device 7 to fix the toner image transferred to the recording material to the recording material. That is, the recording material on which the toner image has been transferred in a section where the second transfer roller 14 faces the intermediate transfer belt 61 is carried to the fixing device 7. The fixing device 7 fixes the toner image transferred to the recoding material to the recording material.

As described above, the arrangement of the image output device 300 is not limited to the electrophotographic image forming apparatus. The arrangement of the image output device 300 may be attained by, for example, an ink-jet image forming apparatus.

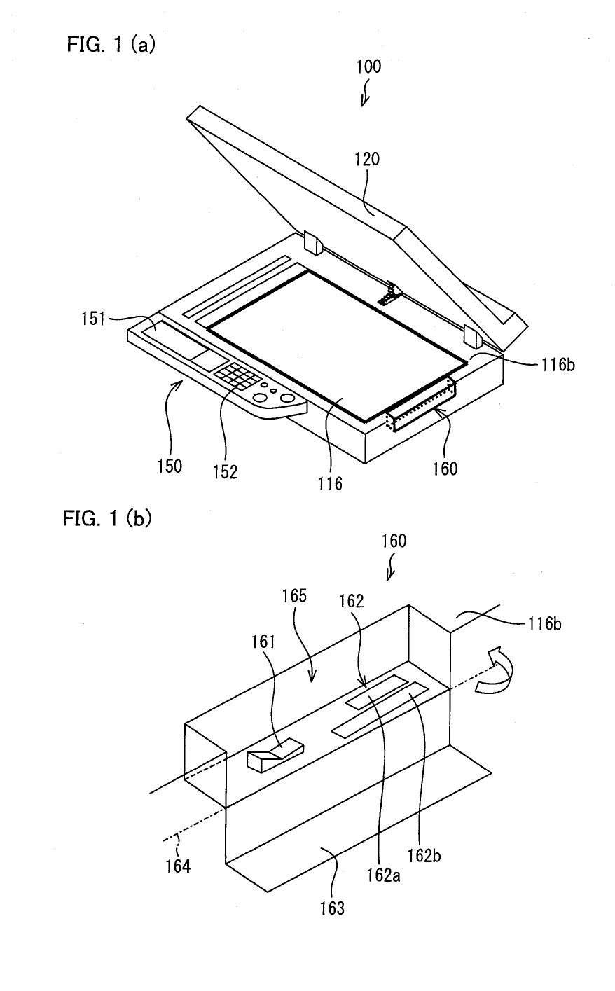

The following describes in detail the operation panel 150 and the memory storage section 160 that are included in the image reading device 100. FIG. 1(a) is a perspective view of the image reading device 100. FIG. 1(b) is a perspective view of the memory storage section 160. Note that FIG. 1(a) does not show the automatic carrying unit 117 with which the platen cover 120 is provided.

As shown in FIG. 1(a), the control panel 150 is provided at an edge of a housing that accommodates the image reading device 100 which edge is closer to a viewer of FIG. 1(a). The control panel 150 includes: an input section 152 which receives an instruction inputted from a user and which then transmits the instruction to the control section 400; and a display section 151 that displays various information to the user. The display section 151 is made up of, for example, a liquid crystal display. The input section 152 is made up of, for example, various setting buttons. The operation panel 150 may include a touch panel including a function of the display section 151 and a function of the input section 152 in a single section. Further, the operation panel 150 of the present embodiment is provided in the housing of the image reading device 100. However, this is not the only option. For example, the operation panel 150 may be provided in a housing that accommodates the image output device 300. Alternatively, the operation panel 150 may be provided in a place other than the housing of the image reading device 100 and the housing of the image output device 300.

Further, as shown in FIG. 1(a), the memory storage section 160 is provided at an edge of the platen 116b. In a case where the platen cover 120 is closed thereby covering the platen 116b, the memory storage section 160 is also covered with the platen cover 120, accordingly. In a case where the platen cover 120 is opened thereby exposing an upper surface of the platen 116b to the outside, an upper surface of the memory storage section 160 is also exposed to the outside, accordingly.

As shown in FIG. 1(b), the memory storage section 160 includes a concavity 165 that is concave downward from the upper surface of the platen 116b, a power switch 161 and the memory attachment section 162 that are provided in the concavity 165, an opening/closing lid 163 that shields an opening of the concavity 165 such that the power switch 161 and the memory attachment section 162 provided in the concavity 165 are shielded from the outside of the memory storage section 160.

The power switch 161 is a switch that switches a power supply of the image forming apparatus 10 to be turned on or off. A user operates the power switch 161. A result of the operation is transmitted to the control section 400. On the basis of the transmitted result, the control section 400 controls the power supply of the image forming apparatus 10 to be turned on or off. Specifically, the image forming apparatus 10 is provided with a power supply circuit (not shown) that supplies an electric power to devices included in the image forming apparatus 10. In a case where the power switch 161 is turned on, the control section 400 commands the power supply circuit to supply the electric power to the devices. In a case where the power switch 161 is turned off, the power section 400 commands the power supply circuit to stop supplying the electric power from the power supply circuit to the devices.

The memory attachment section 162 is a section to which the portable recording medium (removable media) detachable from the image forming apparatus 10 is attached. In a case where the portable recording medium is inserted into the memory attachment section 162, a recording control section 103 included in the image reading device 100 writes data on the portable recording medium, or reads data from the portable recording medium.

For example, in a case where the portable recording medium stores image data to be printed, the recoding control section 103 reads the image data from the portable recording medium according to an instruction of the control section 400, and then transmits the image data to the image processing device 200. The image processing device 200 conducts various image processes with respect to the image data. Thereafter, the image output device 300 conducts a printing process with respect to the image data.

Further, in a case where the portable recording medium stores an updated program of firmware, the recoding control section 103 reads the updated program from the portable recording medium according to the instruction of the control section 400, and then transmits the updated program to the control section 400. The control section 400 updates the firmware installed on the image forming apparatus 10, according to the updated program.

Further, in a case where the portable recording medium stores an option soft (option program) for commanding the image forming apparatus 10 to conduct an option function, the recoding control section 103 reads the option soft from the portable recording medium according to the instruction of the control section 400, and then transmits the option soft to the control section 400. The control section 400 installs the option soft on the image forming apparatus 10.

Examples of the portable recording medium encompass memory cards such as: an SD memory card; an SDHC (registered trademark) memory card; an SDXC (registered trademark) memory card; a miniSD memory card, a microSD (registered trademark) memory card; a microSDHC memory card; an xD picture card (registered trademark); a memory stick (registered trademark); a memory stick PRO; a memory stick Duo (registered trademark); a memory stick PRODuo; a compact flush (registered trademark); a micro drive (registered trademark); and a smart media (registered trademark), and a USB flash drive.

The memory attachment section 162 of the present embodiment is provided with a plurality of memory attachment holes 162a and 162b so that portable recording media different in standard can be attached to the memory attachment section 162. This makes it possible to attach various types of portable recoding media to the image reading device 100. The number of the memory attachment holes and types of the attachable portable recording medium are not particularly limited.

The opening/closing lid 163 is a lid provided rotatably about a rotating shaft (open/close rotating shaft) 164 that extends in a direction parallel to the upper surface of the platen 116b which rotating shaft is provided in a side of the image reading device 100. The opening/closing lid 163 allows the power switch 161 and the memory attachment section 162 to be shielded from the outside of the memory storage section 160 and to be exposed to the outside of the memory attachment section 160. That is, in a case where the opening/closing lid 163 is closed, the power switch 161 and the memory attachment section 162 are shielded from the outside of the memory storage section 160. This makes it possible to prevent the power switch 161 to be accidentally operated and also to prevent the portable recording medium attached to the memory attachment section 162 to be accidentally detached. A material of the opening/closing lid 163 is not particularly limited. The opening/closing lid 163 of the present embodiment is made of transparent ABS (acrylonitrile butadiene styrene) resin. However, the material of the opening/closing lid 163 is not limited to the ABS resin. The opening/closing lid 163 may be made of transparent resins such as acrylic resin and polycarbonate resin.

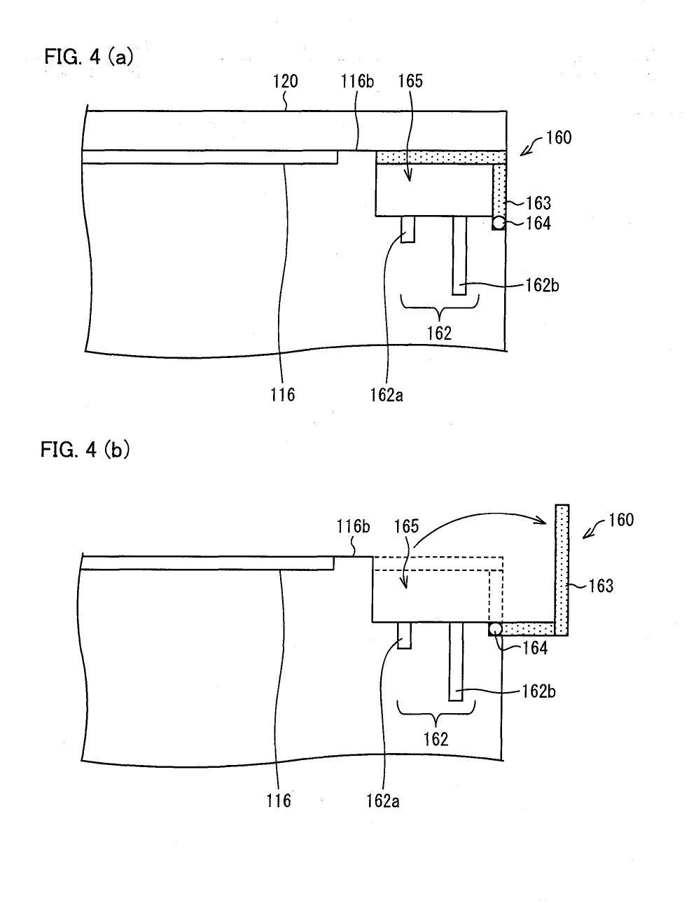

FIG. 4(a) is a cross-sectional view of the image reading device 100 showing a state in which both the opening/closing lid 163 and the platen cover 120 are closed. FIG. 4(b) is a cross-sectional view of the image reading device 100 showing a state in which both the platen cover 120 and the opening/closing lid 163 are open. In a case where both the opening/closing lid 163 and the platen cover 120 are closed (see FIG. 4(a)), it is necessary to open the platen cover 120, and then to open the opening/closing lid 163 so that the opening/closing lid 163 is open and the platen cover 120 is also open (see FIG. 4(b)) in order to detach the portable recording medium attached to the memory attachment section 162 or to turn on/off the power switch 161.

As shown in FIG. 1(b) and FIG. 4(a), the memory storage section 160 has the concavity 165 that is concave downward (to a side far from the platen cover 120) from the upper surface of the platen 116b (a surface facing the platen cover 120) which concavity 165 is provided in a part of the edge of the platen 116b. The memory attachment section 162 is provided in the concavity 165. Further, a depth, of the concavity 165, from the upper surface of the platen 116b and shapes of the memory attachment holes 162a and 162b provided in the memory attachment section 162 are designed such that the memory storage section 160 can accommodate the entire portable recording medium attached to the memory attachment hole 162a or 162b. That is, it is possible to close the opening/closing lid 163 of the memory storage section 160 in which the portable recording medium is attached to the memory attachment hole 162a or 162b.

As described above, the image forming apparatus 10 (image reading device 100) of the present embodiment includes: the platen 116b on which a document to be read is placed; the platen cover 120 rotatably provided so as to cover the platen 116b and expose the platen 116b to the outside; and the memory storage section 160 provided in a region of the edge of the platen 116b which region is to be covered with the platen cover 120, the memory storage section 160 including the power switch 161 and the memory attachment section 162.

The memory storage section 160 is to be covered with the platen cover 120. This makes it possible to reduce a risk that the portable recording medium is accidentally detached by a young child even in a case where the young child touches the image forming apparatus 10 in which the portable recording medium remains attached to the memory attachment section 162 of the memory storage section 160. This also makes it possible to prevent the young child from accidentally swallowing the portable recording medium.

Further, the memory storage section 160 of the image forming apparatus 10 (image reading device 100) of the present embodiment is provided with the opening/closing lid 163. In the case where the opening/closing lid 163 and the platen cover 120 are closed, it is necessary to open the platen cover 120 and then to open the opening/closing lid 163 in order to detach the portable recording medium attached to the memory attachment section 162. This makes it possible to more reliably prevent the young child from accidentally detaching the portable recording medium.

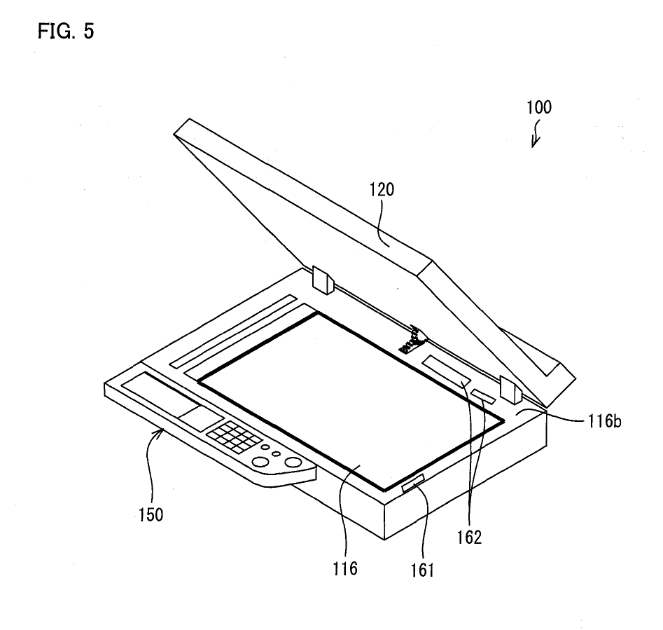

According to the image forming apparatus 10 (image reading device 100) of the present embodiment, the opening/closing lid 163 is provided in the memory storage section 160. This makes it possible to attain the above-described effect. However, the present invention is not limited to this embodiment. The image forming apparatus 10 of the present embodiment may be provided with no opening/closing lid 163. As shown in FIG. 5, for example, the power switch 161 and the memory attachment section 162 may be provided in a peripheral section (frame section) of the platen 116b.

In this case, a concavity (not shown) that is concave downward from the upper surface of the platen 116b may be provided in the peripheral section (frame section) of the platen 116b such that the platen cover 120 does not contact the portable recording medium attached to the memory attachment section 162 even in a case where the platen cover 120 is closed while the portable recording medium is attached to the memory attachment section 162. In this manner, the memory attachment section 162 is provided in the concavity. Alternatively, a concavity that is concave upward from a surface where the platen cover 120 contacts the platen 116b may be provided in a section of the platen cover 120 in which section the platen cover 120 faces the memory attachment section 162, such that the platen cover 120 does not contact the portable recording medium attached to the memory attachment section 162.

Similarly, a concavity (not shown) that is concave downward from the upper surface of the platen 116b is provided in the peripheral section (frame section) of the platen 116b such that the platen cover 120 does not contact the power switch 161 even in a case where the platen cover 120 is closed. In this manner, the power switch 161 is provided in the concavity. Alternatively, a concavity that is concave upward from the surface where the platen cover 120 contacts the platen 116b is provided in the section of the platen cover 120 in which section the platen cover 120 faces the power switch 161, such that the platen cover 120 does not contact the power switch 161.

As shown in FIG. 5, the memory attachment section 162 is provided in the vicinity of an edge of the platen 116b at which edge the platen cover 120 is attached (closer to a backside of the image reading device 100). In this case, it is possible to reduce a risk that a young child contacts the portable recording medium attached to the memory attachment section 162, compared to a case where the memory attachment section 162 is provided in a front surface or a side surface of the platen 116b of the image reading device 100.

Further, according to the image forming apparatus 10 (image reading device 100) of the present embodiment, the opening/closing lid 163 is provided rotatably about the rotating shaft 164 that extends in the direction parallel to the upper surface of the platen 116b which rotating shaft 164 is provided in the side of the image reading device 100. In a case where the opening/closing lid 163 is open, the entire opening/closing lid 163 is positioned outside the image reading device 100. This makes it possible to prevent the platen cover 120 from contacting the opening/closing lid 163 even if the platen cover 120 is accidentally closed while the opening/closing lid 163 remains open. It is therefore possible to prevent the platen cover 120 and the opening/closing lid 163 from being damaged.

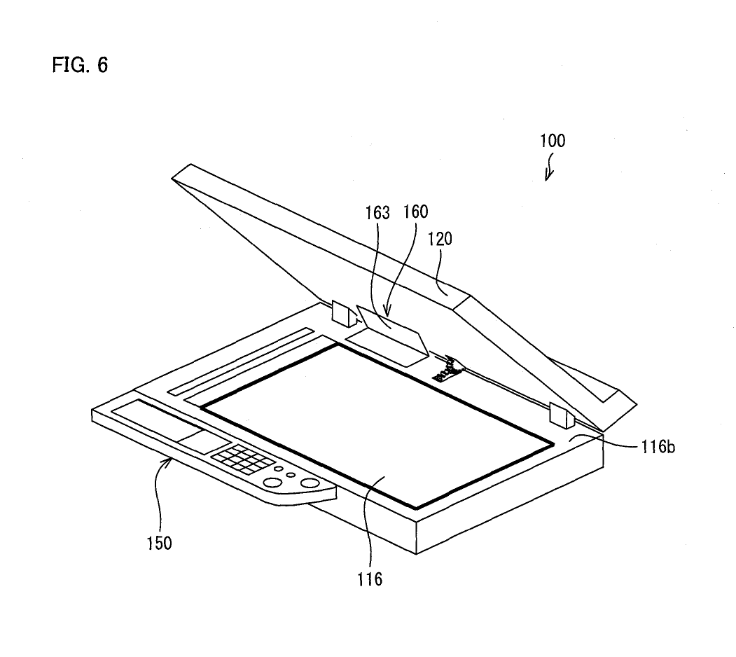

A position where the memory storage section 160 (or the memory attachment section 162) is provided is not limited to the above-described position as long as the platen cover 120 covers the upper surface of the memory storage section 160 in the case where the platen cover 120 is closed. As shown in FIG. 6, for example, the memory storage section 160 may be provided in the vicinity of the edge of the platen 116b at which edge the platen cover 120 is attached (closer to the backside of the image reading device 100). In this case, it is possible to reduce the risk that the young child touches the portable recording medium attached to the memory attachment section 162, compared to the case where the memory attachment section 162 is provided in the front surface or the side surface of the platen 116b of the image reading device 100.

Further, as shown in FIG. 6, the rotating shaft of the opening/closing lid 163 is provided on the upper surface of the platen 116b, and is parallel to a rotating shaft of the platen cover 120. Therefore, even in a case where the platen cover 120 is accidentally closed while the opening/closing lid 163 remains open, the opening/closing lid 163 contacts the platen cover 120 and then is closed by being pressed by the platen cover 120. This makes it possible to prevent the opening/closing lid 163 and the platen cover 120 from being damaged due to contacting the opening/closing lid 163 with the platen cover 120. Furthermore, in the case where the platen cover 120 is closed, the opening/closing lid 163 is constantly closed. This makes it possible to prevent the opening/closing lid 163 from being left open. It is accordingly possible to more reliably prevent the young child from accidentally detaching the portable recording medium attached to the memory attachment section 162.

As described above, the opening/closing lid 163 of the present embodiment is made of the transparent ABS resin. This allows even a user who is unfamiliar with an operation of the image forming apparatus 10 to easily find the power switch 161 and the memory attachment section 162. The user who is unfamiliar with the operation of the image forming apparatus 10 may have difficulty in finding the power switch 161 and the memory attachment section 162 because the power switch 161 and the memory attachment section 162 are provided in a section where the power switch 161 and the memory attachment section 162 are to be covered with not only the platen cover 120 but also the opening/closing lid 163. However, the opening/closing lid 163 of the present embodiment is made of a transparent material. This allows even the user who is unfamiliar with the operation of the image forming apparatus 10 to easily find the power switch 161 and the memory attachment section 162. This also makes it possible to recognize whether or not the portable recording medium is attached to the memory attachment section 162 while the opening/closing lid 163 is closed. It is therefore possible to prevent the portable recording medium from being left undetached. The material of the opening/closing lid 163 is not limited to the ABS resin. The opening/closing lid 163 may be made of other transparent resins such as a polycarbonate and an acrylic.

Further, the opening/closing lid 163 may be an entirely transparent member. Alternatively, a part of the opening/closing lid 163 may be made of the transparent material. For example, a visible portion, of the opening/closing lid 163, positioned in a side of the image forming apparatus 10 in the case where the opening/closing lid 163 is closed as shown in FIG. 4(a) may be an obscure member, and a portion to be covered with the platen cover 120 in the case where the opening/closing lid 163 is closed (portion positioned above the power switch 161 and the memory attachment section 162 in the case where the opening/closing lid 163 is closed) may be a transparent member.

Further, the opening/closing lid 163 of the present embodiment rotates about the rotating shaft such that the memory storage section 160 is opened or closed. However, this is not the only option. For example, the memory storage section 160 may be opened or closed by sliding.

Further, the power switch 161 and the memory attachment section 162 of the present embodiment are provided in the memory storage section 160. However, this is not the only option. At least the memory attachment section 162 may be provided in the memory storage section 160.

Further, the image reading section 110 of the present embodiment is provided below the platen glass 116, and reads a document through the platen glass 116. However, this is not the only option. For example, the image reading section 110 is provided in the platen cover 120, and reads the document placed on a platen region of the platen 116b from above the platen 116b.

As described above, an image reading device of the present invention includes: a platen including a platen region on which a document is to be placed and a frame section that surrounds the platen region; a platen cover provided rotatably about a rotating shaft provided on an edge of the platen such that the platen cover rotates between a position where the platen cover covers at least a part of the frame section and the platen region and a position where the platen cover allows the frame section and the platen region to be exposed to an outside; an image reading section that reads the document placed on the platen region; and a memory attachment section to which a portable recording medium is to be detachably attached, the memory attachment section being provided in a place of the frame section which place is to be covered with the platen cover.

According to the above arrangement, the memory attachment section is provided in the place of the frame section of the platen which place is to be covered with the platen cover. This makes it possible to reduce a possibility that a young child touches the portable recording medium and therefore to reduce a risk that the young child accidentally detaches the portable recording medium even in a case where the portable recording medium remains attached to the memory attachment section.

It may be arranged such that the image reading device includes a memory storage section having a concavity provided in a place of the frame section which place is to be covered with the platen cover, wherein the memory attachment section is provided in the concavity of the memory storage section, and the memory storage section has an opening/closing lid which is opened to expose the concavity to an outside of the memory storage section and closed to shield the concavity from the outside of the memory storage section.

According to the above arrangement, the memory attachment section is provided in the place to be covered with not only the platen cover but also the opening/closing lid. This makes it possible to shield the memory attachment section by the opening/closing lid even in a case where the platen cover is accidentally opened by a young child. It is accordingly possible to reduce the possibility that the young child touches the portable recording medium and therefore to reduce the risk that the portable recording medium is accidentally detached by the young child.

It may be arranged such that the opening/closing lid rotates about an open/close rotating shaft so as to be opened or closed, and the open/close rotating shaft is provided in a place where the opening/closing lid does not contact the platen cover in a case where the platen cover rotates so as to cover the platen region and at least the part of the frame section while the opening/closing lid remains open.

According to the above arrangement, it is possible to prevent the platen cover from contacting the opening/closing lid and therefore to prevent the platen cover and the opening/closing lid from being damaged due to the contact even in a case where the platen cover is closed while the opening/closing lid accidentally remains open.

It may be arranged such that the opening/closing lid rotates about an open/close rotating shaft so as to be opened or closed, the rotating shaft of the platen cover is parallel to the open/close rotating shaft of the opening/closing lid, and in a case where the platen cover rotates so as to cover the platen region and at least the part of the frame section while the opening/closing lid remains open, the opening/closing lid is abutted with the platen cover so as to be rotated to be closed.

According to the above arrangement, the rotating shaft of the platen cover is parallel to the open/close rotating shaft of the opening/closing lid. Therefore, even in the case where the platen cover is closed while the opening/closing lid remains open, the opening/closing lid is abutted with the platen cover so as to be rotated to be closed. It is accordingly possible to prevent the platen cover and the opening/closing lid from being damaged due to the contact. Further, the platen is covered with the platen cover. This makes it possible to constantly cover the memory attachment section with both the opening/closing lid and the platen cover. It is accordingly possible to further reduce the possibility that the young child touches the portable recoding medium and therefore to further reduce the risk that the portable recording medium is accidentally detached by the young child.

It may be arranged such that the image reading device including a power switch in the concavity, the power switch switching such that a power supply of the image reading device is turned on or off.

According to the above arrangement, the power switch of an image forming apparatus is provided in a place to be shielded from the outside by the opening/closing lid in a case where the opening/closing lid of the memory storage section is closed. That is, the power switch is provided in the place to be covered with not only the platen cover but also the opening/closing lid. This makes it possible to prevent the power supply of the image reading device from being accidentally operated by the young child. Further, this also makes it possible to prevent data stored in the portable recording medium from being accidentally deleted or modified by the young child who accidentally turns on the power supply, even in a case where the power supply is left turned off while the portable recording medium remains attached.

It may be arranged such that at least a part of the opening/closing lid is made of a transparent material.

According to the above arrangement, it is possible recognize the memory attachment section (or both the memory attachment section and the power switch) provided in the memory storage section even in a case where the opening/closing lid is closed. This allows a user to easily find the memory attachment section (or both the memory attachment section and the power switch).

An image forming apparatus of the present invention, includes: any one of the above-described image reading devices; and an image output device that forms, on a recording material, an image in accordance with at least one of image data read by the image reading device and image data read from the portable recording medium.

According to the above arrangement, the memory attachment section is provided in the place of the platen which place is to be covered with the platen cover. This makes it possible to reduce the possibility that the young child touches the portable recording medium and therefore to reduce the risk that the portable recording medium is accidentally detached by the young child even in a case where the portable recording medium remains attached to the memory attachment section.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to an image reading device from which a portable recording medium is detachable, and an image forming apparatus including the image reading device.

### REFERENCE SIGNS LIST

10: image forming apparatus
100: image reading device
116: platen glass
116b: platen
120: platen cover
150: control panel
160: memory storage section
161: power switch
162: memory attachment section
162a: memory attachment hole
162b: memory attachment hole
163: opening/closing lid
164: rotating shaft (open/close rotating shaft)
165: concavity
200: image processing device
300: image output device
400: control section

1. An image reading device, comprising:
a platen including a platen region on which a document is to be placed and a frame section that surrounds the platen region;
a platen cover provided rotatably about a rotating shaft provided on an edge of the platen such that the platen cover rotates between a position where the platen cover covers at least a part of the frame section and the platen region and a position where the platen cover allows the frame section and the platen region to be exposed to an outside;
an image reading section that reads the document placed on the platen region; and
a memory attachment section to which a portable recording medium is to be detachably attached,
the memory attachment section being provided in a place of the frame section which place is to be covered with the platen cover.

2. The image reading device as set forth in claim 1, comprising a memory storage section having a concavity provided in a place of the frame section which place is to be covered with the platen cover,
wherein the memory attachment section is provided in the concavity of the memory storage section, and
the memory storage section has an opening/closing lid which is opened to expose the concavity to an outside of the memory storage section and closed to shield the concavity from the outside of the memory storage section.

3. The image reading device as set forth in claim 2, wherein:
the opening/closing lid rotates about an open/close rotating shaft so as to be opened or closed, and
the open/close rotating shaft is provided in a place where the opening/closing lid does not contact the platen cover in a case where the platen cover rotates so as to cover the platen region and at least the part of the frame section while the opening/closing lid remains open.

4. The image reading device as set forth in claim 2 wherein:
the opening/closing lid rotates about an open/close rotating shaft so as to be opened or closed,
the rotating shaft of the platen cover is parallel to the open/close rotating shaft of the opening/closing lid, and
in a case where the platen cover rotates so as to cover the platen region and at least the part of the frame section while the opening/closing lid remains open, the opening/closing lid is abutted with the platen cover so as to be rotated to be closed.

5. The image reading device as set forth in claim 2, comprising:
a power switch in the concavity, the power switch switching such that a power supply of the image reading device is turned on or off.

6. The image reading device as set forth in claim 2, wherein:
at least a part of the opening/closing lid is made of a transparent material.

7. An image forming apparatus, comprising:
an image reading device as set forth in claim 1; and
an image output device that forms, on a recording material, an image in accordance with at least one of image data read by the image reading device and image data read from the portable recording medium.
